(19) United States
(12) Patent Application Publication
(10) Pub. No.: US 2003/0135716 A1
(43) Pub. Date: Jul. 17, 2003

(54) Method of creating a high performance virtual multiprocessor by adding a new dimension to a processor's pipeline

(76) Inventor: Gil Vinitzky, Azor (IL)

Correspondence Address: DANIEL J SWIRSKY, PO BOX 2345, BEIT SHEMESH, 99544, IL

(21) Appl. No.: 10/043,223

(22) Filed: Jan. 14, 2002

(51) Int. Cl. G06F 9/00

(52) U.S. Cl. 712/220

(57) ABSTRACT

A method is provided for converting a computer processor configuration having a k-phased pipeline into a virtual multithreaded processor, including dividing each pipeline phase of the processor configuration into a plurality n of sub-phases, and creating at least one virtual pipeline within the pipeline, the virtual pipeline including k sub-phases.

### FIELD OF THE INVENTION

The present invention relates to computer processor architecture in general, and more particularly to multithreading computer processor architectures and pipelined computer processor architectures.

### BACKGROUND OF THE INVENTION

Pipelined computer processors are well known in the art. A typical pipelined computer processor increases overall execution speed by separating the instruction processing function into four pipeline phases. This phase division allows for an instruction to be fetched (IF) during the same clock cycle as a previously-fetched instruction is decoded (D), a previously-decoded instruction is executed (E), and the result of a previously-executed instruction is written back into its destination (WB). Thus, the total elapsed time to process a single instruction (i.e., fetch, decode, execute, and write-back) is four clock cycles. However, the average throughput is one instruction per machine cycle because of the overlapped operation of the four pipeline phases.

In many computing applications that are executed by pipelined computer processors a large percentage of instruction processing time is wasted due to pipeline stalling and idling. This is often due to cache misses and latency in accessing external caches or external memory following the cache misses, or due to interdependency between successively executed instructions that necessitates a time delay of one or more clock cycles in order to stabilize the results of a prior instruction before that instruction's results can be used by a subsequent instruction.

Increasing the number of pipeline phases in a given processor results in a processor that may operate at a higher clock frequency. For example, doubling the number of pipeline phases by splitting each phase into two sub-phases, where each sub-phase's execution time is half of the original clock cycle, will result in a pipeline that is twice as deep as the original pipeline, and will enable the processor to operate at up to twice the clock frequency relative to the clock frequency of the original processor. However, the processor's performance with respect to an application is not doubled, since its performance is reduced due to pipeline stalling and idling, given the increased overlap of subsequently executed instructions. Furthermore, increasing the number of pipeline phases in a given processor will result in a new processor that is not compatible with the original processor, as the cycle-by-cycle execution pattern is different, since new idling cycles are inserted. Thus, applications written for the original processor would likewise be incompatible with the new processor and would need to be recompiled and optimized for use with the new processor.

One technique for reducing stalling and idling in pipelined computer processors is hardware multithreading, where instructions are processed during otherwise idle cycles. Applying hardware multithreading to a given processor may result in improved performance, due to reduced stalling and idling. However, as is the case with increased pipeline phases, the new multithreaded processor is not compatible with the original processor, as the cycle-by-cycle execution pattern is different from that of the original processor, since idling cycles are eliminated. An application that is compiled and optimized for execution by the original processor will generally include idling operations to adjust for pipeline limitations and interdependency between subsequent instructions. Thus, applications written for the original processor would need to be recompiled and optimized for use with the new multithreading processor in order to take advantage of the reduced need for idling operations and of other benefits of multithreading.

### SUMMARY OF THE INVENTION

The present invention provides a method of converting a computer processor into a virtual multiprocessor that overcomes disadvantages of the prior art. The present invention improves throughput efficiency and exploits increased parallelism by introducing a combination of multithreading and pipeline splitting to an existing and mature processor core. The resulting processor is a single physical processor that operates as multiple virtual processors, where each of the virtual processors is equivalent to the original processor.

In one aspect of the present invention a method is provided for converting a computer processor configuration having a k-phased pipeline into a virtual multithreaded processor, including dividing each pipeline phase of the processor configuration into a plurality n of sub-phases, and creating at least one virtual pipeline within the pipeline, the virtual pipeline including k sub-phases.

In another aspect of the present invention the method further includes executing a different thread within each one of the virtual pipelines.

In another aspect of the present invention the executing step includes executing any of the threads at an effective clock rate equal to the clock rate of the k-phased pipeline.

In another aspect of the present invention the dividing step includes determining a minimum cycle time T=1/f for the computer processor configuration and dividing each pipeline phase of the processor configuration into the plurality n of sub-phases, where each sub-phase has a propagation delay of less than T/n.

In another aspect of the present invention the method further includes replicating the register set of the processor configuration, and adapting the replicated register sets to simultaneously store the machine states of the threads.

In another aspect of the present invention the method further includes selecting any of the threads at a clock cycle, and activating at the clock cycle the register set that is associated with the selected thread.

In another aspect of the present invention any of the steps are applied to a single-threaded processor configuration.

In another aspect of the present invention any of the steps are applied to a multithreaded processor configuration.

In another aspect of the present invention any of the steps are applied to a given processor configuration a plurality of times for a plurality of different values of n, thereby creating a plurality of different processor configurations.

In another aspect of the present invention any of the steps are applied to a given processor configuration a plurality of times for a plurality of different values of n until a target processor performance level is achieved.

In another aspect of the present invention the dividing step includes selecting a predefined target processor performance value, and selecting a value of n being in predefined association with the predefined target processor performance level.

It is appreciated throughout the specification and claims that the term “processor” may refer to any combination of logic gates that is driven by one or more clock signals and that performs and processes one or more streams of input data or any stored data elements.

The disclosures of all patents, patent applications and other publications mentioned in this specification and of the patents, patent applications and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a 4-phased pipeline of a computer processor, useful in understanding the present invention;

FIG. 2 is a simplified conceptual illustration of a 4-threaded, 4-phased pipeline of a computer processor, useful in understanding the present invention;

FIG. 3 is a simplified conceptual illustration of an 8-phased pipeline of a computer processor, useful in understanding the present invention;

FIG. 4 is a simplified conceptual illustration of a 2-threaded, 8-phased pipeline of a computer processor operating as a virtual multithreaded processor (VMP), constructed and operative in accordance with a preferred embodiment of the present invention; and

FIG. 5 is a simplified flowchart illustration of a method of converting a computer processor into a virtual multithreaded processor (VMP), operative in accordance with a preferred embodiment of the present invention.

### DETAILED DESCRIPTION OF PREFERRED EMBODIMENTS

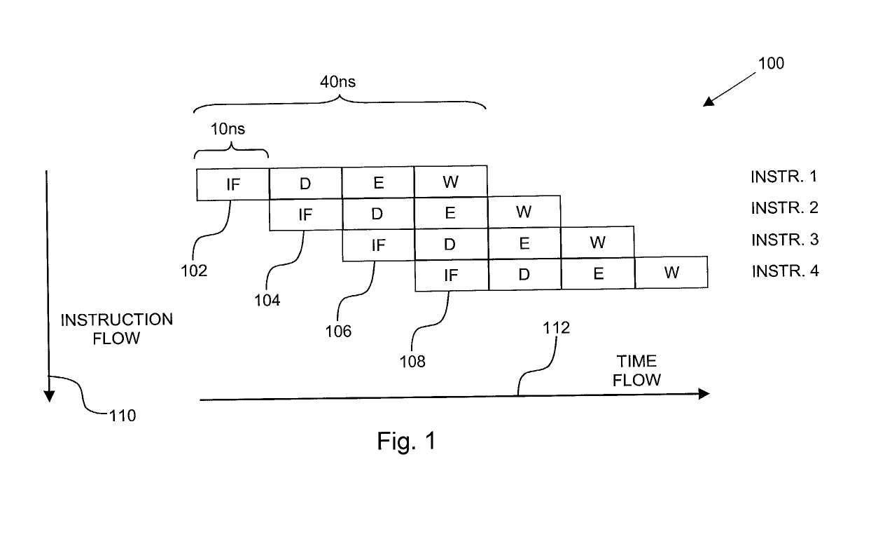

Reference is now made to FIG. 1, which is a simplified conceptual illustration of a 4-phased pipeline of a computer processor, useful in understanding the present invention. In FIG. 1 a pipeline 100 is shown into which four successive instructions 102, 104, 106, and 108 have been introduced along an instruction flow vector 110. Each instruction is processed in four phases along a time flow vector 112. In the first phase, labeled IF, the instruction is fetched. In the second phase, labeled D, the instruction is decoded. In the third phase, labeled E, the instruction is executed. Finally, in the fourth phase, labeled W, the execution results are written to memory or other storage. It may be seen that all four instructions 102, 104, 106, and 108 are processed simultaneously, but at different pipeline phases. The propagation delay of an instruction through pipeline 100 is four machine cycles. A new instruction is issued into pipeline 100 every clock cycle, such that the throughput of pipeline 100 at steady state is one instruction per cycle. By way of example, where each phase/clock cycle lasts 10 nanoseconds, each instruction takes 40 nanoseconds to process, the processing of each subsequent instruction begins 10 nanoseconds after the processing of the previous instruction has begun, and the throughput of pipeline 100 at steady state is one instruction every 10 nanoseconds.

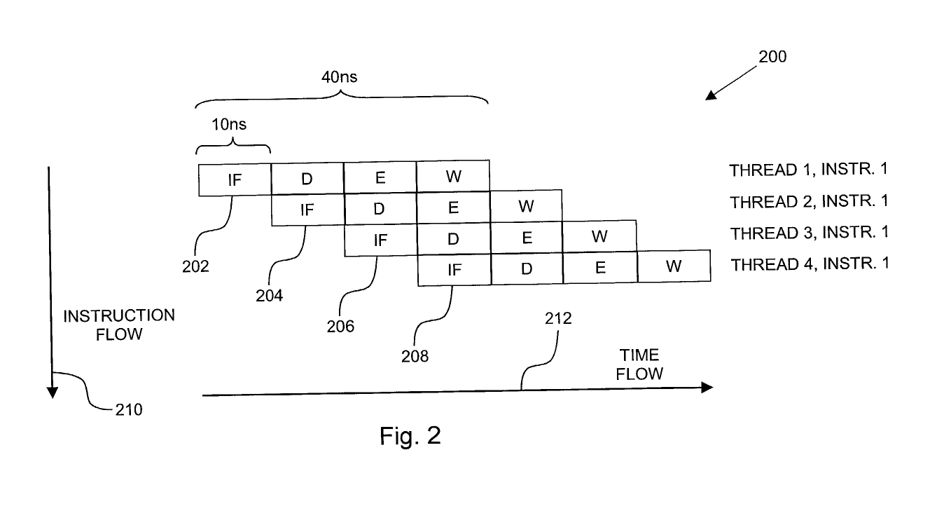

Reference is now made to FIG. 2, which is a simplified conceptual illustration of a 4-threaded, 4-phased pipeline of a computer processor, useful in understanding the present invention. FIG. 2 shows a pipeline 200 that is similar to pipeline 100 of FIG. 1 with the notable exception that it simultaneously processes instructions from four different threads. An instruction from each thread is alternatingly issued into the pipeline every fourth machine cycle. The throughput of each thread is ¼ instructions per cycle. The total throughput of pipeline 200, executing 4 threads, is 1 instruction per cycle. There is no increase in the pipeline's throughput or clock frequency as compared with pipeline 100 of FIG. 1, however, pipeline stalling and idling is reduced or eliminated due to the independence of successively executed instructions.

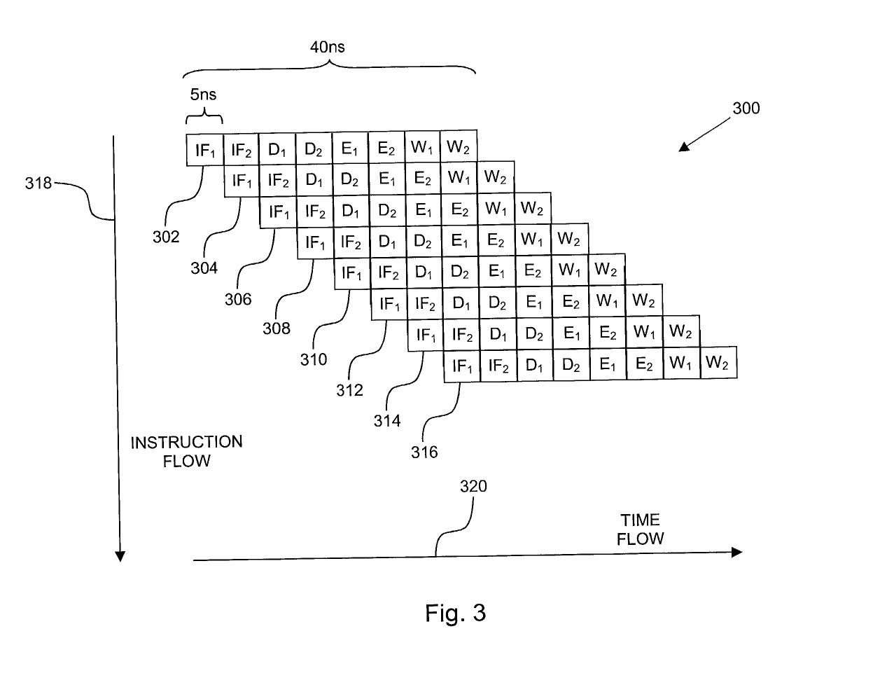

Reference is now made to FIG. 3, which is a simplified conceptual illustration of an 8-phased pipeline of a computer processor, useful in understanding the present invention. FIG. 3 shows pipeline 100 of FIG. 1 after each pipeline phase has been split into two sub-phases. Thus, for example, fetching an instruction is now performed in two sub-phases, with each sub phase lasting one clock cycle. In FIG. 3 a pipeline 300 is shown into which eight successive instructions 302, 304, 306, 308, 310, 312, 314, and 316 have been introduced along an instruction flow vector 318. Each instruction is processed in four phases along a time flow vector 320. As in FIG. 1, all eight instructions 302, 304, 306, 308, 310, 312, 314, and 316 are processed simultaneously, but at different pipeline phases. The propagation delay of an instruction through pipeline 300 is eight machine cycles. A new instruction is issued into pipeline 300 every clock cycle, such that the throughput of pipeline 300 at steady state is one instruction per cycle. However, since the execution time of each phase is half the execution time of pipeline 100 of FIG. 1, the clock frequency of pipeline 300 may be increased by a factor of two as compared with pipeline 100. Continuing with the example of FIG. 1, while each instruction still takes 40 nanoseconds to process, each phase/clock cycle now lasts only 5 nanoseconds, and the processing of each subsequent instruction begins 5 nanoseconds after the processing of the previous instruction has begun. The throughput of pipeline 300 at steady state is thus one instruction every 5 nanoseconds, representing an increase in throughput of a factor of two compared with the pipeline of FIG. 1.

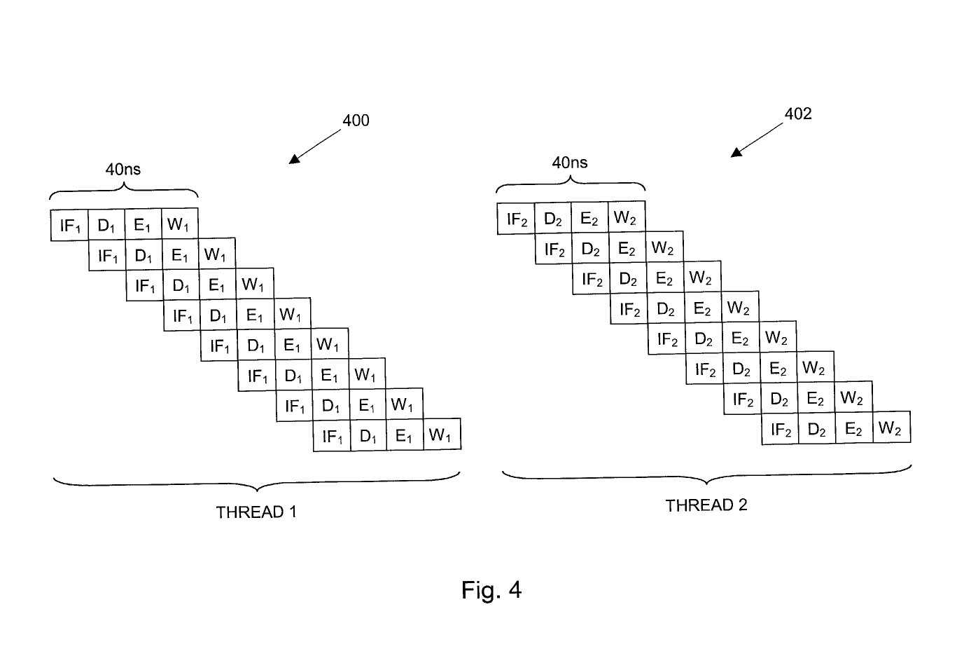

Reference is now made to FIG. 4, which is a simplified conceptual illustration of a 2-threaded, 8-phased pipeline of a computer processor operating as a virtual multithreaded processor (VMP), constructed and operative in accordance with a preferred embodiment of the present invention. FIG. 4 shows pipeline 200 of FIG. 2, representing pipeline 100 of FIG. 1 after pipeline phase division, separated into two virtual pipelines 400 and 402, each supporting a different thread. As each phase of pipeline 100 has been split into two sub-phases, thereby increasing the clock rate by a factor of 2, each of the virtual pipelines 400 and 402 may execute its thread at an effective clock rate equal to the clock rate of a processor having pipeline 100.

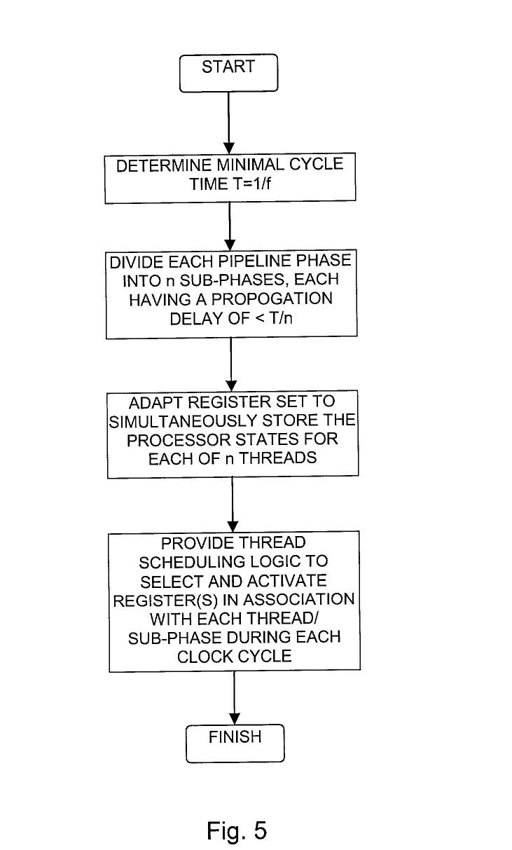

Reference is now made to FIG. 5, which is a simplified flowchart illustration of a method of converting a computer processor into a virtual multithreaded processor (VMP), operative in accordance with a preferred embodiment of the present invention. In the method of FIG. 5 a single-threaded processor with a k-phased pipeline is converted into an n-threaded VMP with n*k-phased pipeline. The VMP is compatible with the original processor, being able to run the same binary code as the original processor without modification. The VMP operates at a clock frequency that is up to n times higher than the original clock frequency, due to the n-fold deeper pipeline. Up to n interleaved threads, where each thread is an independent program, are run simultaneously. The VMP compensates for pipeline penalties, such as stalling and idling, that are usually introduced when adding phases to a conventional pipeline.

The VMP acts as n virtual processors served by n virtual pipelines, where each virtual processor time-shares one physical pipeline. Each of the n virtual processors is compatible with the original processor and runs at an n-fold faster clock frequency, but is activated every n'th clock cycle. Thus, it is as if each virtual processor operates at the same frequency as the original processor. Each of the n virtual pipelines is a k-phased pipeline, equivalent to the original processor's single k-phased pipeline, and is activated every n phases of the n*k phased physical pipeline. Each application that is capable of being executed by the original processor is executed as one of the n threads by one of the n virtual processors in the same manner. No change to the application software is required, as each virtual pipeline behaves exactly as the original processor pipeline with respect to instruction processing and pipeline phases.

In the method of FIG. 5 the minimal machine cycle time T=1/f of the original processor is determined, where f is the maximal clock frequency of the original processor. This information is preferably ascertained from a given list of processor parameters or is calculated from a description of the processor's logic, such as from an RTL, netlist, schematics or other formal description. Each of the pipeline phases is then divided into n sub-phases, where the propagation delay of each sub-phase is smaller than T/n, resulting in a processor configuration whose pipeline is n-fold deeper than the original processor. The set of registers that store the processor state information, referred to herein as the register set, is then adapted to simultaneously store the multiple machine states of the n threads. This may be achieved by using any register set extension technique. In one such technique the register set is replaced by n identical register sets, where each of the n register sets is dedicated to one of the threads. Selection logic is then used to activate one of the n register sets at each clock cycle. An alternative method replaces the register set with a “public” register pool, whose individual registers are dynamically allocated to the n threads, depending on their required resources, such that each thread owns a part of the public register file that is sufficient to store its machine states. Selection logic is then used to activate the appropriate register at each cycle as indicated by the part of the register file that is assigned to the active thread and according to the active thread's register access request. Yet another alternative is a combination of the two above mentioned methods, where the extended register set is composed of n partial register sets, each dedicated to one of the n threads, and one register file, whose individual registers are dynamically allocated to the n threads depending on the resources required by each thread, such that each thread has its own register set in addition to a share in the register file, the combination of which is sufficient to store the state of each thread.

Continuing with the method of FIG. 5, selection logic is implemented to select the appropriate register to be written into or read from at each cycle, depending on the requirements of the active thread which is in a register access phase of pipeline execution at a particular machine cycle. The selection logic is typically driven by a thread scheduler which activates a selected thread at each clock cycle, such that an instruction from the selected thread is fetched from memory and placed into the pipeline. The register set that is associated with the selected thread is also activated at the proper clock cycle. In one method of thread scheduling each of the n register sets is sequentially activated at consecutive clock cycles, such that each set is activated every n'th cycle. Alternatively, any other method of thread scheduling may be used.

It is appreciated that the method of FIG. 5 may be applied, not only to a single-threaded processor, but to a multithreaded processor as well, where a t-threaded processor with a k-phased pipeline is converted into an equivalent n*t-threaded processor with an n*k-phased pipeline. The resulting VMP is compatible with the original processor in that it may execute the same compiled code without modification.

While the present invention has been described with reference to a thread scheduling scheme where the threads are interleaved on a cycle-by-cycle basis and the thread's real-time execution pattern is compatible with the original processor's cycle-by-cycle real-time behavior, the present invention may utilize any thread-scheduling scheme. Thus, the thread scheduler may select the thread to be activated at each clock cycle based on a combination of criteria, such as thread priority, expected behavior of the selected thread, and the effect of selecting a specific thread on the overall utilization of the processor resources and on the overall performance.

The method of FIG. 5 may be applied, not only to processor cores, but to any synchronous logic unit or other electronic circuit that performs logical or arithmetic operations on input data and that is synchronized by a clock signal. Each execution phase may be split into n sub-units, with the input data stream being split into n independent threads and the unit's internal memory elements which store internal stream-related states being replicated to support the n simultaneously executed threads.

The method of FIG. 5 may be applied to a given processor several times, with different values of n, to create different processor configurations. A typical set of processor configurations may include an original single-threaded processor with a k-phased pipeline and an operating frequency up to f, a 2-threaded processor with a 2k-phased pipeline and an operating frequency up to 2f, a 3-threaded processor with 3k-phased pipeline and an operating frequency up to 3f, and so on. Additionally, a desired processor performance level may be defined, with the method of FIG. 5 being applied to a given processor with a phase-splitting factor of n, such that a processor configuration is achieved that satisfies a desired processor performance level. Different processor performance levels may be defined, each having a different predefined value of n. A performance level may be defined, for example, as the average time needed to perform a given task, or the average number of instructions executed per second. The average may be based on statistics taken over a representative application execution or a benchmark program. Thus, in the present invention, an n-fold deepening of a pipeline to support n-threads will increase the performance by a factor of up to n. Therefore, specifying a performance level of up to x, 2x, 3x, or 4x, will translate to n=1, 2, 3, or 4 respectively.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method of converting a computer processor configuration having a k-phased pipeline into a virtual multithreaded processor, the method comprising:
dividing each pipeline phase of said processor configuration into a plurality n of sub-phases; and
creating at least one virtual pipeline within said pipeline, said virtual pipeline comprising k sub-phases.

2. A method according to claim 1 and further comprising executing a different thread within each one of said virtual pipelines.

3. A method according to claim 2 wherein said executing step comprises executing any of said threads at an effective clock rate equal to the clock rate of said k-phased pipeline.

4. A method according to claim 1 wherein said dividing step comprises:
determining a minimum cycle time T=1/f for said computer processor configuration; and
dividing each pipeline phase of said processor configuration into said plurality n of sub-phases, wherein each sub-phase has a propagation delay of less than T/n.

5. A method according to claim 2 and further comprising:
replicating the register set of said processor configuration; and
adapting said replicated register sets to simultaneously store the machine states of said threads.

6. A method according to claim 5 and further comprising:
selecting any of said threads at a clock cycle; and
activating at said clock cycle the register set that is associated with said selected thread.

7. A method according to claim 1 wherein any of said steps are applied to a single-threaded processor configuration.

8. A method according to claim 1 wherein any of said steps are applied to a multithreaded processor configuration.

9. A method according to claim 1 wherein any of said steps are applied to a given processor configuration a plurality of times for a plurality of different values of n, thereby creating a plurality of different processor configurations.

10. A method according to claim 1 wherein any of said steps are applied to a given processor configuration a plurality of times for a plurality of different values of n until a target processor performance level is achieved.

11. A method according to claim 1 wherein said dividing step comprises:
selecting a predefined target processor performance value; and
selecting a value of n being in predefined association with said predefined target processor performance level.
